(19) United States
(12) Patent Application Publication
(10) Pub. No.: US 2026/0111082 A1
(43) Pub. Date: Apr. 23, 2026

(54) TOUCH PANEL INCLUDING SENSOR SIGNAL LINES WITH IMPROVED RESISTANCE UNIFORMITY AND VISIBILITY AND DISPLAY DEVICE COMPRISING THE SAME

(71) Applicant: G2TOUCH Co., LTD., Seongnam-si (KR)

(72) Inventors: Ki Hwan OH, Seongnam-si (KR); Hwa Joo NOH, Seongnam-si (KR); Ji Woon WON, Seongnam-si (KR); Seung Ha LEE, Seongnam-si (KR)

(21) Appl. No.: 19/331,357

(22) Filed: Sep. 17, 2025

(30) Foreign Application Priority Data
Oct. 22, 2024 (KR) 10-2024-0144724

(51) Int. Cl. G06F 3/041

(52) U.S. Cl. CPC G06F 3/04164

(57) ABSTRACT

Disclosed herein is a touch panel including sensor signal lines with improved resistance uniformity and visibility and a display device including the same. The touch panel includes: a plurality of sensor signal lines each connected to a corresponding one of the touch sensors to transmit a touch signal or a control signal, wherein the sensor signal lines are formed of a transparent conductive material, and at least one of the sensor signal lines includes a plurality of micro-patterns formed by removing the transparent conductive material in a predetermined shape. The touch panel according to the present invention can minimize a difference in resistance between the sensor signal lines, despite differences in length between the sensor signal lines, while improving visibility of the sensor signal lines.

### CROSS-REFERENCE TO RELATED APPLICATION

This patent document claims the benefit of Korean Patent Application No. 10-2024-0144724, filed on Oct. 22, 2024, the entire disclosure of which is incorporated by reference for all purposes as if fully set forth herein.

### TECHNICAL FIELD

The present invention relates to a touch panel and a display device and, more particularly, to a touch panel including sensor signal lines with improved resistance uniformity and visibility and a display device including the same.

### BACKGROUND

A touch panel is an input device that is generally formed on or coupled to a display device, such as a liquid crystal display (LCD), a plasma display panel (PDP), an organic light emitting diode (OLED) display, and an active matrix organic light emitting diode (AMOLED) display, and functions to generate a position signal corresponding to a location where an object, such as a finger or stylus, makes contact. Touch panels have broad applications in various fields, including portable electronic devices, industrial terminals, and digital information devices (DIDs) and applications thereof are continuing to expand.

A capacitive touch panel is a device that determines the presence of a touch by sensing a change in an electrical signal generated from the capacitance between a touch pattern on the panel and a human finger or a touch input tool having similar conductive characteristics thereto.

Referring to FIG. 1, a plurality of touch sensors 110 of a touch panel 100 is arranged in a matrix having a plurality of columns Col 0 to Col 4 and a plurality of rows Row 0 to Row 5.

A plurality of sensor signal lines connects the touch sensors 110 to a touch IC 120.

Sensor signal lines connected to touch sensors in Row 0 have a greater resistance value than sensor signal lines connected to touch sensors located in Row 5.

Since the sensor signal lines have a resistance value proportional to the length thereof, sensor signal lines connected to touch sensors located far from the touch IC 120 tend to have a greater resistance value than sensor signal lines connected to touch sensors located close to the touch IC 120.

To solve this problem, there has been proposed a method of increasing the line width of sensor signal lines connected to touch sensors located far from the touch IC 120 However, increase in line width of the sensor signal lines results in decrease in thickness of the sensor signal lines, making the sensor signal lines prone to cracking and increasing the risk of defects.

In addition, since the line width of the sensor signal lines varies depending on the location of the touch sensors, visibility of the touch panel can be reduced.

Therefore, there is a need for a touch panel including sensor signal lines having a uniform resistance value, regardless of the location of touch sensors.

### RELATED LITERATURE

### Patent Document

Patent Document 1: Korean Patent Laid-open Publication No. 10-1374312 (Jun. 14, 2014)
Patent Document 2: Korean Patent Laid-open Publication No. 10-1609992 (Mar. 31, 2016)

### SUMMARY

Embodiments of the present invention have been conceived to solve such problems in the art and it is an aspect of the present invention to provide a touch panel that can minimize a difference in resistance between sensor signal lines, despite differences in length between the sensor signal lines, while improving visibility of the sensor signal lines, and a display device including the same.

In accordance with one aspect of the present invention, a touch panel including touch sensors with improved uniformity in resistance and visibility includes: a plurality of sensor signal lines each connected to a corresponding one of the touch sensors to transmit a touch signal or a control signal, wherein the sensor signal lines are formed of a transparent conductive material, and at least one of the sensor signal lines includes a plurality of micro-patterns formed by removing the transparent conductive material in a predetermined shape.

The plurality of micro-patterns may be arranged to form at least one column with a vertical gap VG between each micro-pattern in a longitudinal direction of the sensor signal line.

The number of columns formed by the plurality of micro-patterns may be determined to minimize a difference in resistance between a pair of adjacent sensor signal lines.

The number of columns formed by the plurality of micro-patterns may increase as a length of the sensor signal line increases or as a width of the sensor signal line increases.

The predetermined shape of the micro-patterns may be a chevron shape.

The chevron-shaped micro-patterns are arranged to form at least one row with a horizontal gap between each micro-pattern in a transverse direction of the sensor signal line, wherein the row may be defined by a virtual line connecting vertices of the chevron-shaped micro-patterns.

The chevron-shaped micro-patterns in a pair of adjacent columns are arranged such that the vertices thereof point in opposite directions, respectively, in the transverse direction of the sensor signal line to improve visibility of the sensor signal line.

A resistance value of the sensor signal line decreases as the number of columns formed by the plurality of micro-patterns increases.

The number of columns formed by the plurality of micro-patterns is determined depending on a position of a touch driver integrated circuit (IC) configured to process the touch signal and output the control signal.

In accordance with another aspect of the present invention, a display device includes the touch panel set forth above.

Embodiments of the present invention provide a touch panel including sensor signal lines with improved resistance uniformity and visibility, which can minimize a difference in resistance between sensor signal lines, despite differences in length between the sensor signal lines, while improving visibility of the sensor signal lines, and a display device including the same.

In the touch panel and the display device including sensor signal lines with improved resistance uniformity and visibility according to the present invention, a resistance value of each sensor signal line can be adjusted depending on the number of columns of micro-patterns included in the sensor signal line.

### BRIEF DESCRIPTION OF THE DRAWINGS

The above and other aspects, features, and advantages of the present invention will become apparent from the detailed description of the following embodiments in conjunction with the accompanying drawings:

FIG. 1 is a schematic diagram of a touch panel with touch sensors arranged in a matrix;

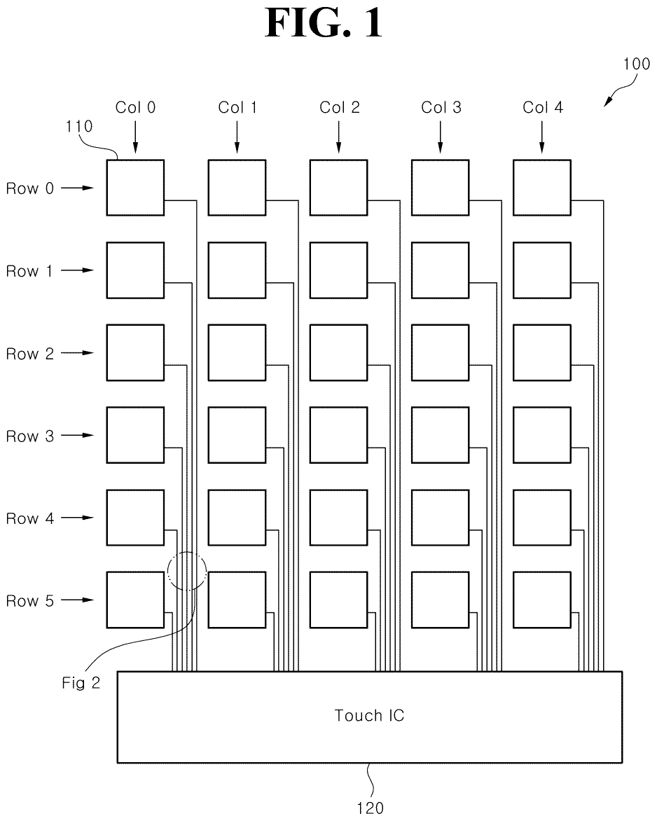

FIG. 2 is an enlarged view of a sensor signal line including chevron-shaped micro-patterns according to one embodiment of the present invention; and

FIG. 3 is a diagram illustrating a relationship between the chevron-shaped micro-patterns according to one embodiment of the present invention.

### DETAILED DESCRIPTION OF EMBODIMENTS

Hereinafter, embodiments of the present invention will be described in detail with reference to the accompanying drawings.

In accordance with one embodiment of the present invention, a touch panel including sensor signal lines with improved resistance uniformity and visibility includes a plurality of touch sensors arranged in a matrix having a plurality of columns and a plurality of rows.

Each of the sensor signal lines is connected to a corresponding one of the touch sensors to transmit a touch signal or a control signal between the touch sensor and a touch driver integrated circuit (IC).

In one embodiment, the sensor signal line is formed of a transparent conductive material. For example, the transparent conductive material may include indium tin oxide (ITO).

According to the present invention, a plurality of micro-patterns may be formed on the sensor signal line to achieve uniform resistance across different sensor signal lines.

The micro-pattern is a region of the sensor signal line where ITP, the material of the sensor signal line, has been removed in a predetermined shape. By way of example, the micro-pattern may be formed on the sensor signal line by removing the conductive material in the corresponding region through etching in a predetermined shape.

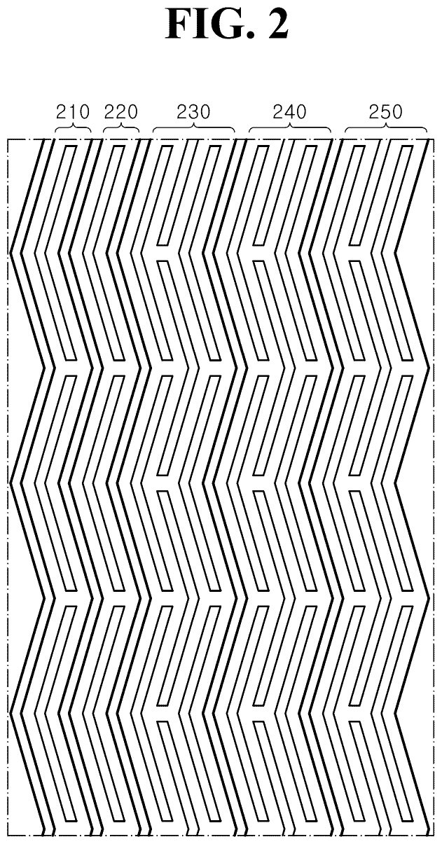

Referring to FIG. 2, each of the sensor signal lines 210 to 250 includes a plurality of chevron-shaped micro-patterns in a longitudinal direction thereof.

As described above, the micro-pattern is formed by removing the transparent conductive material in a chevron shape. That is, the transparent conductive material remains unremoved in other regions of the sensor signal line than the chevron-shaped micro-patterns.

In one embodiment, only some sensor signal lines connected to touch sensors located relatively far from the touch driver IC include a plurality of micro-patterns, while other sensor signal lines do not include the micro-patterns.

In one embodiment, the shapes of the micro-patterns formed by removing the transparent conductive material of the sensor signal line may be determined according to an outer contour of the sensor signal line. That is, the chevron-shaped micro-pattern shown in FIG. 2 is merely an example.

In one embodiment, the plurality of micro-patterns is arranged to form at least one column with a vertical gap VG between each micro-pattern in the longitudinal direction of the sensor signal line.

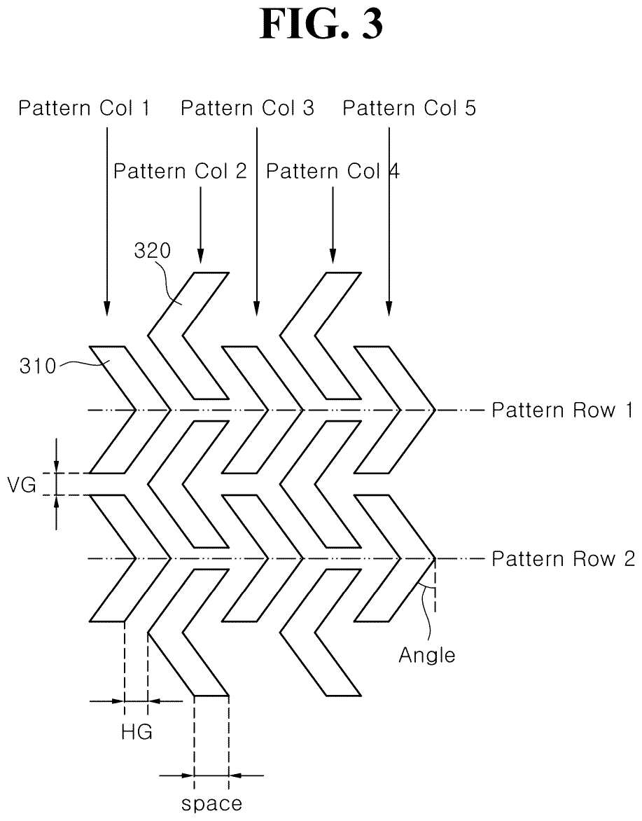

Referring to FIG. 3, the plurality of micro-patterns forms five columns Pattern Col 1 to Pattern Col 5. FIG. 3 shows an enlarged view of some regions of the plurality of micro-patterns, and the numbers of columns and rows formed by the plurality of micro-patterns may be greater or fewer than illustrated in FIG. 3.

In FIG. 3, Pattern Col 2 comprises three chevron-shaped micro-patterns arranged in a line with a vertical gap (VG) between each micro-pattern in the longitudinal direction of the sensor signal line. Micro-patterns forming Pattern Col 4 are similar to those forming Pattern Col 2.

In addition, the plurality of chevron-shaped micro-patterns is arranged to form at least one row with a horizontal gap (HG) between each micro-pattern in a transverse direction of the sensor signal line. Here, a row of micro-patterns is defined by a virtual line connecting vertices of the chevron-shaped micro-patterns.

Referring to FIG. 3, the plurality of micro-patterns forms two rows Pattern Row 1 and Pattern Row 2.

In one embodiment, to improve visibility of the sensor signal line, the chevron-shaped micro-patterns in a pair of adjacent columns are arranged such that vertices thereof point in opposite directions, respectively, in the transverse direction of the sensor signal line.

Referring to FIG. 3, the vertices of the micro-patterns forming Pattern Col 1 point to the right side in the drawing, while the vertices of the micro-patterns forming in Pattern Col 2 point to the left side in the drawing. As the chevron-shaped micro-patterns in a pair of adjacent columns are arranged such that the vertices thereof point in opposite directions, respectively, as shown in FIG. 3, the sensor signal line can maintain good visibility, despite partial removal of the conductive material for formation of the micro-patterns.

In one embodiment, the number of columns formed by the plurality of micro-patterns is determined to minimize a difference in resistance between a pair of adjacent sensor signal lines. The number of columns formed by the plurality of micro-patterns increases as the length of the sensor signal line increases or as the width of the sensor signal line increases.

Referring to FIG. 2, a sensor signal line 220 has one column of micro-patterns, while another sensor signal line 230 has three columns of micro-patterns.

Since the length of the sensor signal line 230 is greater than the length of the sensor signal line 220, the number of columns of micro-patterns formed on the sensor signal line 230 is greater than the number of columns of micro-patterns formed on the sensor signal line 220 to reduce a difference in resistance between the sensor signal line 230 and the sensor signal line 220.

In one embodiment, as the number of columns of micro-patterns increases, a resistance value of the sensor signal line decreases. That is, for sensor signal lines having the same length, forming a greater number of columns of micro-patterns results in a lower resistance than forming a smaller number of columns of micro-patterns.

In one embodiment, the number of columns formed by the plurality of micro-patterns may be determined based on the location of the touch driver IC that processes a touch signal and outputs a control signal. Specifically, when the touch driver IC is located at one side of the touch panel, the number of columns of micro-patterns formed on sensor signal lines connected to touch sensors located at the other side of the touch driver IC may be greater than the number of columns of micro-patterns formed on sensor signal lines connected to touch sensors located at the same side as the touch driver IC to achieve uniform resistance across different sensor signal lines.

The embodiments of the present invention described in detail above may be implemented individually or combined with one another. It will be apparent to those skilled in the art that the present is not limited to the foregoing embodiments and the accompanying drawings and that various modifications, changes, alterations, and equivalent embodiments can be made without departing from the spirit and scope of the invention.

1. A touch panel including a plurality of touch sensors, the touch panel comprising:
a plurality of sensor signal lines each connected to a corresponding one of the touch sensors to transmit a touch signal or a control signal,
wherein the sensor signal lines are formed of a transparent conductive material, and
at least one of the sensor signal lines comprises a plurality of micro-patterns formed by removing the transparent conductive material in a predetermined shape.

2. The touch panel according to claim 1, wherein the plurality of micro-patterns is arranged to form at least one column with a vertical gap VG between each micro-pattern in a longitudinal direction of the sensor signal line.

3. The touch panel according to claim 2, wherein the number of columns formed by the plurality of micro-patterns is determined to minimize a difference in resistance between a pair of adjacent sensor signal lines.

4. The touch panel according to claim 3, wherein the number of columns formed by the plurality of micro-patterns increases as a length of the sensor signal line increases or as a width of the sensor signal line increases.

5. The touch panel according to claim 1, wherein the predetermined shape of the micro-patterns is a chevron shape.

6. The touch panel according to claim 5, wherein the chevron-shaped micro-patterns are arranged to form at least one row with a horizontal gap between each micro-pattern in a transverse direction of the sensor signal line, the row being defined by a virtual line connecting vertices of the chevron-shaped micro-patterns.

7. The touch panel according to claim 6, wherein the chevron-shaped micro-patterns in a pair of adjacent columns are arranged such that vertices thereof point in opposite directions, respectively, in the transverse direction of the sensor signal line to improve visibility of the sensor signal line.

8. The touch panel according to claim 3, wherein a resistance value of the sensor signal line decreases as the number of columns formed by the plurality of micro-patterns increases.

9. The touch panel according to claim 3, wherein the number of columns formed by the plurality of micro-patterns is determined depending on a position of a touch driver integrated circuit (IC) configured to process the touch signal and output the control signal.

10. A display device comprising the touch panel according to claim 1.
